(19) United States
(12) Patent Application Publication
(10) Pub. No.: US 2010/0263412 A1
(43) Pub. Date: Oct. 21, 2010

(54) Leather-marking method and its device

(76) Inventor: CHIEH HUANG CHANG, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,641

(22) Filed: Apr. 15, 2009

(51) Int. Cl. C14B 5/00; C14B 1/00

(52) U.S. Cl. 69/2; 69/21

(57) ABSTRACT

A leather-marking method and its device mainly includes a marking machine combined with a special marking needle having ball shaped needle head such that the marking needle will be punched on the leather with a certain degree of force to form the indents but not penetrate through. And, the marking needle will be displaced through an automatic control method to create the continuous or intermittent indented lines sequentially on the leathers and become the distinct symbols that can conveniently be provided for the subsequent processing procedures of leathers to obtain the practicability.

### PRIOR ART OF THE INVENTION

The leather has a very wide usage range such as the leather shoe, leather bag, leather clothing, etc. that are all made by cutting and sewing of leather. However, while the known leather proceed the pattern cutting, stitching, or other surface treatments, there is a need to make the reticle or mark on the leather. The ordinary traditional way of operation is to draw lines by man and smear on the leather with printing ink. The line drawing by man not only is time and labor consuming but also is not precise. Furthermore, due to the easy bump and touching, it will cause the leather be polluted and the error aroused in the slopwork, and the unnecessary consumables will be produced. And, the method of ink smearing-printing also tarnishes the leather easily and cannot be easily cleaned. Thus, it is obviously that the traditional method of leather reticle is not ideal enough, and it waits to be improved.

### SUMMARY OF THE INVENTION

The present invention is to provide a leather-marking method and its device, which is including a marking machine combined with a special marking needle. Through a setting of the computer programs, the pre-determined indented lines can be marked on the leathers. The said indented lines will disappear after a period of time. It thus can over come the drawback that the printing is remained on the leather.

Now, by cooperating with the drawings, the structure, characteristics and implementation method of present invention will be described hereafter.

### BRIEF DESCRIPTION OF THE DRAWINGS

FIG. 1 is a front view diagram of a marking device in the present invention.

FIG. 2 is a side view diagram of a marking device in the present invention.

FIG. 3 is a three dimensional diagram of a marking pin in the present invention.

FIG. 4 is an implementing embodiment's diagram of the present invention having an indented line formed on the leather.

FIG. 5 is an modified embodiment's diagram of the present invention.

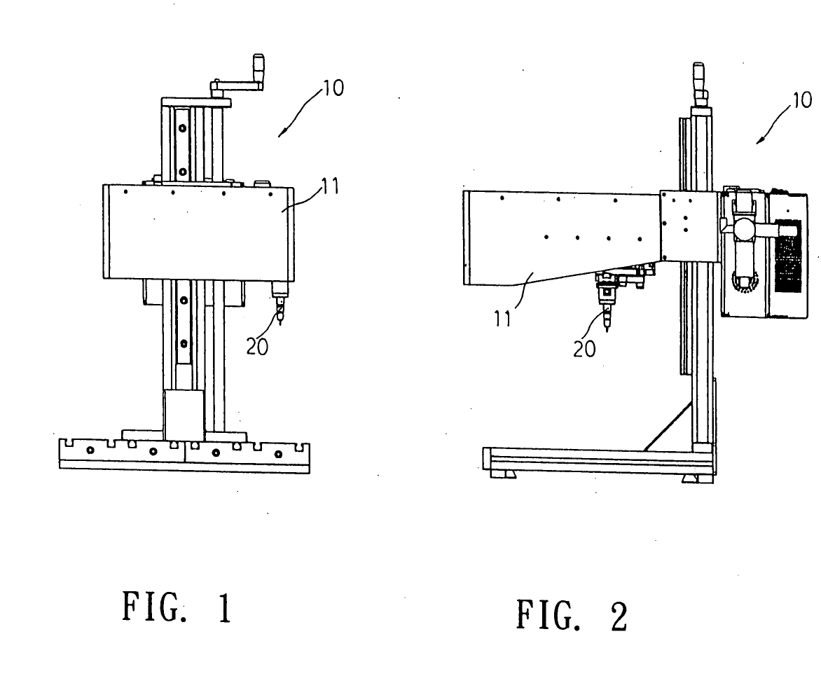

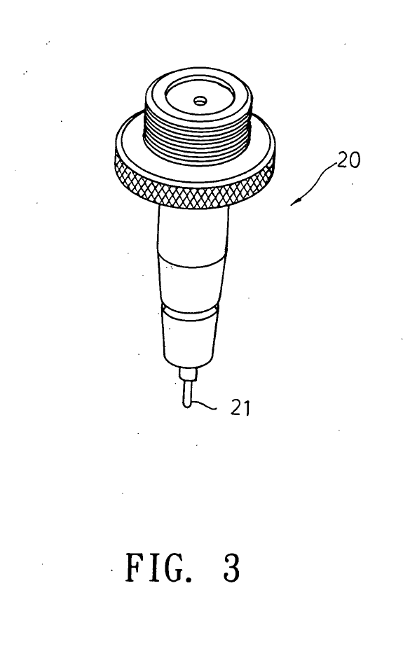

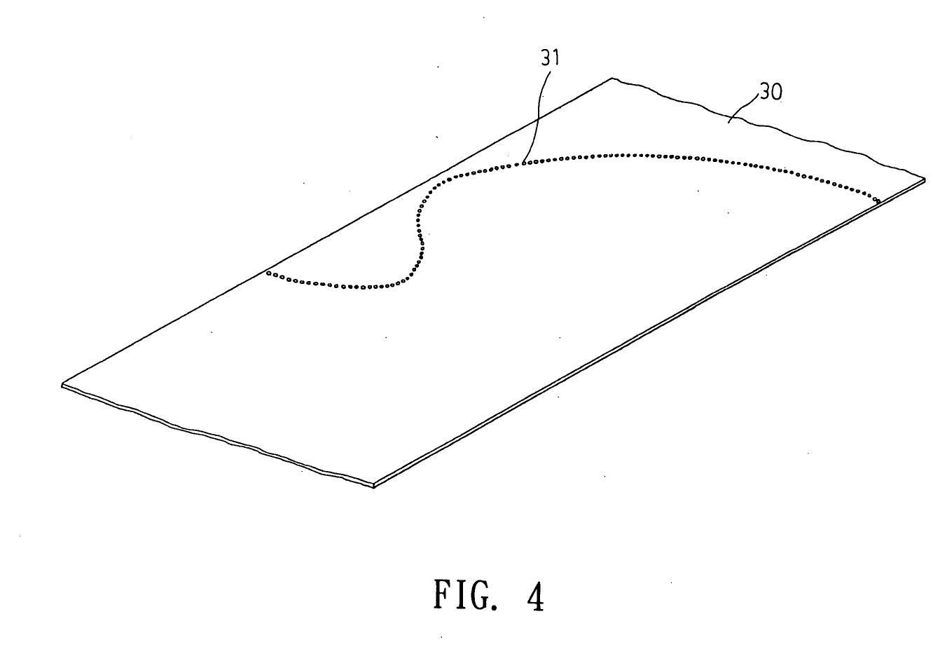

### DETAILED DESCRIPTION OF THE PREFERRED EMBODIMENT

The present invention is a leather-marking method and its device. The said device is including a marking machine 10 with a movable workbench 11 having a marking needle 20 assembled under it and forming a ball shaped needle head 21 in the bottom end of needle. The marking machine 10 can be built-in with the pre-determined computer programs to control the moving of marking needle 21 to any positions in cooperation with the workbench 11, after that the downward punching stroke are performed. While the leather 30 is laid under, the ball shaped needle 21 will punch the leather surface by a certain force according to a pre-set control method and form an indent 31 on the leather 30 without penetrating the leather 30. Under this operation, the continuous or intermittent indented lines are formed according to the required figures through the method of repeatedly punching on the leather 30 at different positions, and the purpose of symbol marking on the leather is achieved.

Due to that the leather 30 has the elasticity restoring force, the line marked according to the present invention will disappear after a period of time. During this period, the setting of punching force in marking needle 20 can be adjusted according to the material quality of leather 30 and the required time for subsequent treatment to determine the depth of indent 31. Generally, the said indent can be controlled to maintain the time period of 7 to 14 days.

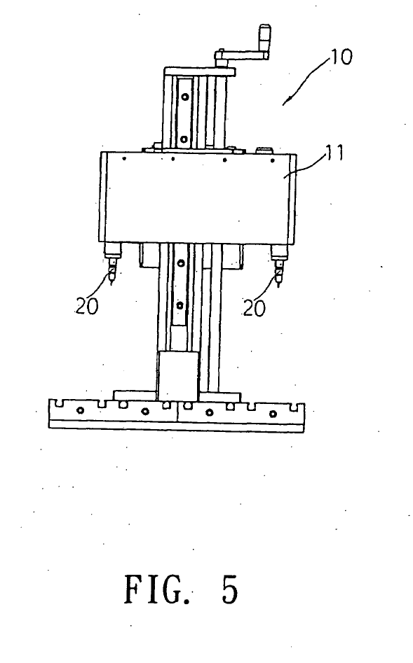

Please refer further to those shown in FIG. 5. In order to raise the efficiency of the present invention, two or more than two sets of marking needles 20 are combined under the workbench 11 to double the marking effect for the working object through this.

By summarizing the above, through the implementation of the marking method in the present invention by utilizing the marking needle with ball shaped needle head to punch repeatedly on the leather surface at different positions and form the required marking lines, the accuracy and efficiency are raised a lot if compared with the manpower method of prior art, and there is no problem of producing the remained printing ink or pollution. Therefore, the present invention has already equipped with the required conditions of approving the patent.

I claim:

1. A leather-marking method mainly using a special marking needle with ball shaped needle head combined on a marking machine, the pressure exerted on the leather through the method of punching to form a non-penetrating indent, and an indent line created by sequentially punch-printing indents at different positions then becoming a distinct symbol that can conveniently be provided as the identifying marks for the subsequent processing procedures of leathers.

2. A leather-marking method according to claim 1, wherein the deepness or shallowness of said indent can be controlled by the setting of marking force.

3. A leather-marking method according to claim 1, wherein the indent will disappear after a certain period of time due to leather's own elasticity.

4. A leather-marking device including a marking machine with a workbench having a marking needle assembled under the workbench, the marking needle characterized in its ball shaped needle head can arbitrarily be moved to any specified positions.

5. A leather-marking device according to claim 4, wherein two or more than two sets of marking needles are combined under the workbench.
